(19) United States
(12) Patent Application Publication
(10) Pub. No.: US 2026/0118935 A1
(43) Pub. Date: Apr. 30, 2026

(54) OBTAINING POWER DISTRIBUTION DATA FOR MANAGING A SYSTEM USING A DIAGNOSTIC DEVICE

(71) Applicant: Dell Products L.P., Round Rock, TX (US)

(72) Inventor: CHRISTOPHER BAUER ATKINSON, Woodstock, GA (US)

(21) Appl. No.: 18/931,460

(22) Filed: Oct. 30, 2024

(51) Int. Cl. G06F 1/30

(52) U.S. Cl. CPC G06F 1/30

(57) ABSTRACT

Methods and systems for managing operation of a system are disclosed. To manage operation of the system, a diagnostic device may be used to obtain data from a dual purpose cable that simultaneously carries power and data between a data processing system of the system and a power system of the system. The diagnostic device may include a component (e.g., an inductive amplifier) that may snoop the data carried by the dual purpose cable by sampling and interpreting a magnetic field emanating outside the dual purpose cable. The data may include control information for managing distribution of power and may subsequently be used to update operation of the system when a power distribution issue is identified in the system.

### FIELD

Embodiments disclosed herein relate generally to managing operation of a system. More particularly, embodiments disclosed herein relate to managing operation of the system by using a diagnostic device to obtain data regarding power distribution between a power system of the system and a data processing system of the system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2 shows an interaction diagram in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a system. The system may provide computer-implemented services to any type and number of other devices and/or users of the system. The computer-implemented services may include any quantity and type of such services.

To provide the computer-implemented services, the system may include a power system and any number of data processing systems. For example, the power system may distribute power to the data processing systems for use in providing at least a portion of the computer-implemented services. A data processing system of the data processing systems may consume a portion of the power distributed by the power system.

Because each data processing system of the data processing systems may consume a different level of power and/or the level of power may exceed a power capacity of the power system, a power distribution issue may arise. The power distribution issue may include, for example, a communication issue between the power system and the data processing system that may negatively impact an ability of the power system to distribute desired power to the data processing system.

To facilitate distribution and/or consumption of the power, a dual purpose cable may connect the power system to the data processing system. For example, the dual purpose cable may directly connect a component of the power system (e.g., a power distribution unit of the power system) to a component of the data processing system (e.g., a power supply of the data processing system). Additionally, the dual purpose cable may simultaneously carry power and data between the data processing system and the power system.

To improve a likelihood that desired computer-implemented services may be provided by the system, control information relevant to the distribution of power in the system may be obtained based on an identification of the power distribution issue in the system. To obtain the control information, a diagnostic device may be positioned with the dual purpose cable to snoop the data carried by the dual purpose cable.

To snoop the data, a component of the diagnostic device (e.g., an inductive amplifier) may sample a magnetic field emanating outside the dual purpose cable (e.g., due to an electromagnetic signal propagating along the dual purpose cable as electrical current flows across the dual purpose cable). The sampled magnetic field may be interpreted to obtain at least a portion of the data that may include, for example, the control information for managing distribution of power. Once obtained, the control information may be used, for example, to debug an undesired operation of the system and/or update operation of the system.

Thus, embodiments disclosed herein may provide an improved method for managing operation of a system by using a diagnostic device to obtain data from a magnetic field emanating from a dual purpose cable connecting a power system of the system to a data processing system of the system. By doing so, operation of the system may be updated based at least on the data to provide computer-implemented services that may be less likely to be impacted by a power distribution issue.

In an embodiment, a method for managing operation of a system is provided. The method may include: (i) making an identification of a power distribution issue in the system; (ii) based on the identification: (a) identifying a dual purpose cable between a data processing system of the system and a power system of the system, the dual purpose cable simultaneously carrying power and data between the data processing system and the power system; (b) positioning a diagnostic device with the dual purpose cable; (c) while the diagnostic device is positioned with the dual purpose cable: (i) snooping the data carried by the dual purpose cable; (ii) updating operation of the system using, at least in part, the snooped data; and (iii) providing computer implemented services using the updated system.

Snooping the data may include: (i) sampling, using a component of the diagnostic device, a magnetic field emanating outside the dual purpose cable due to an electromagnetic signal propagating along the dual purpose cable on which the data carried by the dual purpose cable is encoded; and (ii) interpreting the sampled magnetic field to obtain at least a portion of the data;

The component may be an inductive amplifier.

The data may include control information for managing distribution of power from the power system to the data processing system.

The control information may also be used for managing distribution of the power to other data processing systems of the system.

The control information may be used to limit the distribution of the power to reduce a likelihood of undesired operation of the power system.

The power distribution issue may be a communication issue between the power system and the data processing system.

The dual purpose cable may directly connect the power system to the data processing system.

The power system may include a power distribution unit to which the dual purpose cable is directly connected.

The power distribution unit may be adapted to received power and provide power supply level power to the data processing system, the data processing system including a power supply to which the dual purpose cable is directly connected.

The diagnostic device may be in series with a power loop between the data processing system and the power system, the dual purpose cable being part of the power loop.

The diagnostic device may be outside of a power loop between the data processing system and the power system, the dual purpose cable being part of the power loop.

In an embodiment, a non-transitory media is provided. The non-transitory media may include instructions that when executed by a processor cause the computer-implemented method to be performed.

In an embodiment, a diagnostic device is provided. The diagnostic device may include the non-transitory media and a processor, and may perform the computer-implemented method when the computer instructions are executed by the processor.

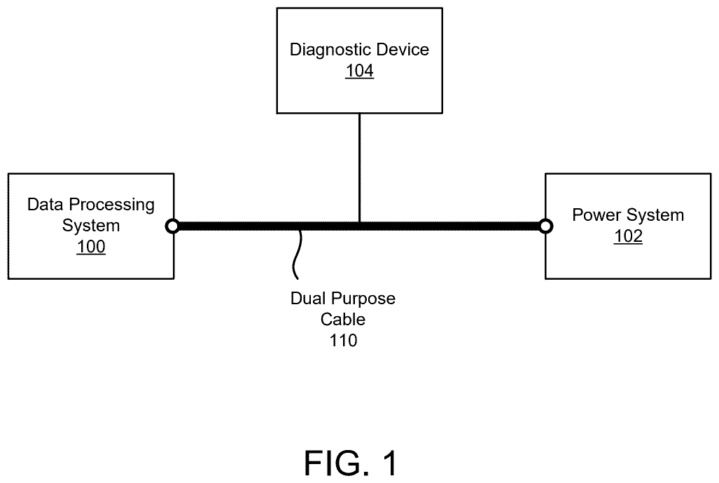

Turning to FIG. 1, a block diagram illustrating a system in accordance with an embodiment is shown. The system shown in FIG. 1 may provide any number and/or types of computer-implemented services (e.g., to user of the system and/or devices operably connected to the system).

To provide the computer-implemented services, the system of FIG. 1 may include data processing system 100, power system 102, diagnostic device 104, and dual purpose cable 110. The computer-implemented services may be provided by one or more components of the system of FIG. 1.

Data processing system 100 may provide at least a portion of the computer-implemented services. The computer-implemented services may include, for example, data storage services, data processing services, and/or any other types of services. To provide the computer-implemented services, data processing system 100 may host any number and/or types of hardware resources. To operate, the hardware resources may utilize power consumed from power system 102.

Power system 102 may distribute power to data processing system 100 and any number of other data processing systems (not shown). For example, power system 102 and data processing system 100 (and/or the any number of other data processing systems) may be implemented in a server chassis to provide at least a portion of the computer-implemented services. To distribute the power to data processing system 100A, power system 102 may include a power distribution unit adapted to receive power (e.g., via an external power source, utility power, etc.) and provide power supply level power to data processing system 100A.

To facilitate distribution and/or consumption of the power, dual purpose cable 110 may connect power system 102 to data processing system 100. For example, dual purpose cable 110 may directly connect a component of power system 102 (e.g., a power distribution unit) to a component of data processing system 100 (e.g., a power supply of data processing system 100). Additionally, dual purpose cable 110 may simultaneously carry power and data between data processing system 100 and power system 102.

However, a power distribution issue may occur when power required for operation of data processing system 100 is incompatible with power distributed by power system 102. For example, the power distribution issue may include a communication issue in which a power supply level power of data processing system 100 exceeds a capacity (e.g., a power distribution rate) of a power distribution unit of power system 102. Consequently, a quality and/or availability of computer-implemented services provided by the system may be negatively impacted.

In general, embodiments disclosed herein relate to systems, devices, and methods for managing operation of a system. To manage the operation of the system, a diagnostic device may be used to obtain data relevant to managing distribution of power between a power system of the system to a data processing system of the system. By doing so, operation of the system may be updated based, at least in part, on the data.

When a power distribution issue is identified in the system, an entity tasked with managing operation of the system (e.g., an administrator, engineer, technician, etc.) may identify dual purpose cable 110 that may connect data processing system 100 to power system 102. For example, to identify dual purpose cable 110, the entity may use at least a component of diagnostic device 104 (e.g., an inductive amplifier) to trace dual purpose cable 110, and/or perform any other actions to distinguish dual purpose cable 110 from any number and/or types of additional cables that may exist in an environment of the system.

Once identified, diagnostic device 104 may be positioned with dual purpose cable 110 to snoop data carried by dual purpose cable 110 while data processing system 100 and/or power system 102 are connected by dual purpose cable 110. To snoop the data, the inductive amplifier of diagnostic device 104 may sample a magnetic field emanating outside dual purpose cable 110. The magnetic field may be a result of an electromagnetic signal propagating along dual purpose cable 110 as electrical current flows across dual purpose cable 110.

The sampled magnetic field may include encoded data (e.g., by data processing system 100 and/or power system 102) that may be interpreted to obtain at least a portion of the data that may include control information for managing distribution of power. For example, to interpret the encoded data, diagnostic device 104 may decode at least a portion of the encoded data (e.g., via demodulation), identify the control information based on a signal information schema, and/or any other processes.

Once obtained, the control information may be used to debug an undesired operation of the system and/or update operation of the system. For example, based on control information that identifies identities of data processing system 100 and/or power system 102, and/or power consumption/distribution rates of data processing system 100 and/or power system 102, operation of data processing system 100 and/or power system 102 may be updated (e.g., by modifying connectivity of data processing system 100 and/or power system 102) to repair the power distribution issue.

To provide the above noted functionality, the system may include data processing system 100, power system 102, diagnostic device 104, and dual purpose cable 110. Each of these components is discussed below.

Data processing system 100 may, as discussed above, provide various computer-implemented services to users thereof and/or other devices operably connected to data processing system 100. To provide the computer-implemented services, data processing system 100 may host various hardware resources that may consume power (e.g., electrical power) to operate. To manage the consumption of power, the hardware resources may include a power supply unit that may, for example, convert power received from power system 102 to power compatible to be used by other hardware resources of data processing system 100. While connected to power system 102 via dual purpose cable 110, data processing system 100 may communicate information to power system 102 regarding power supply level power (e.g., a power consumption rate desired by the power supply unit and/or other components of data processing system 100).

Power system 102 may, as discussed above, provide power distribution services to data processing system 100 and/or other data processing systems (not shown). To do so, power system 102 may include a power distribution unit that may be adapted to receive power (e.g., from an external power source, utility power, etc.) and provide desired power to data processing system 100. To provide power to data processing system 100, the power distribution unit of power system 102 may be directly connected to data processing system 100 via dual purpose cable 110. While connected to data processing system 100 via dual purpose cable 110, power system 102 may communicate information to data processing system 100 regarding power distribution (e.g., power distribution rates).

Diagnostic device 104 may, as discussed above, provide power diagnostic services. To provide the power diagnostic services, diagnostic device 104 may include, for example, an inductive amplifier that may sample a magnetic field emanating outside dual purpose cable 110 when diagnostic device 104 is positioned within range of dual purpose cable 110. To sample the magnetic field, diagnostic device 104 may be in series with a power loop between data processing system 100 and power system 102 (e.g., via an intermediary connection), outside of the power loop (e.g., an external device that may tap information without physical contact with dual purpose cable 110), and/or any other form factors.

Diagnostic device 104 may subsequently interpret the sampled magnetic field to obtain at least a portion of data carried by dual purpose cable 110. The portion of data may be used (e.g., by an operator of diagnostic device 104) to update operation of the system.

Dual purpose cable 110 may, as discussed above, simultaneously carry power and data between data processing system 100 and power system 102. For example, dual purpose cable 110 may be implemented using any type of power line communication standards to transmit the data. To carry the power and the data between data processing system 100 and power system 102, dual purpose cable 110 may be directly connected to a component of power system 102 (e.g., a power distribution unit) and a component of data processing system 100 (e.g., a power supply unit). For example, a first connector of dual purpose cable 110 may be connected to a port of the power distribution unit while a second connector of dual purpose cable 110 may be connected to a port of the power supply unit. By being connected as such, dual purpose cable may be part of a power loop between data processing system 100 and power system 102.

While carrying the power from power system 102 to data processing system 100, the power may generate electromagnetic signals that propagate along dual purpose cable 110 (e.g., due to alternating current) that may in turn, emanate a magnetic field outside dual purpose cable 110. The magnetic field may subsequently be detected by diagnostic device 104 to snoop data encoded on the electromagnetic signals transmitted by data processing system 100 and/or power system 102.

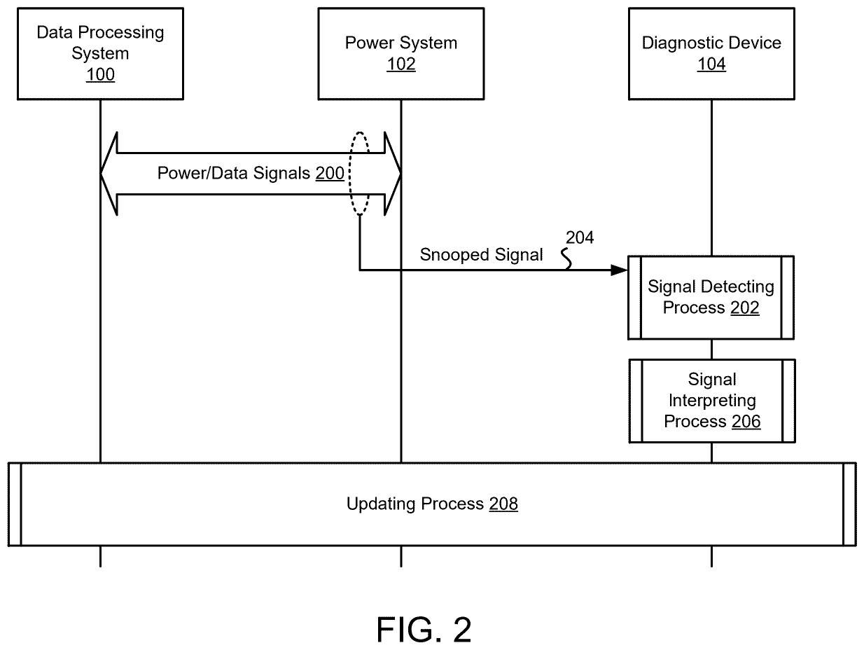

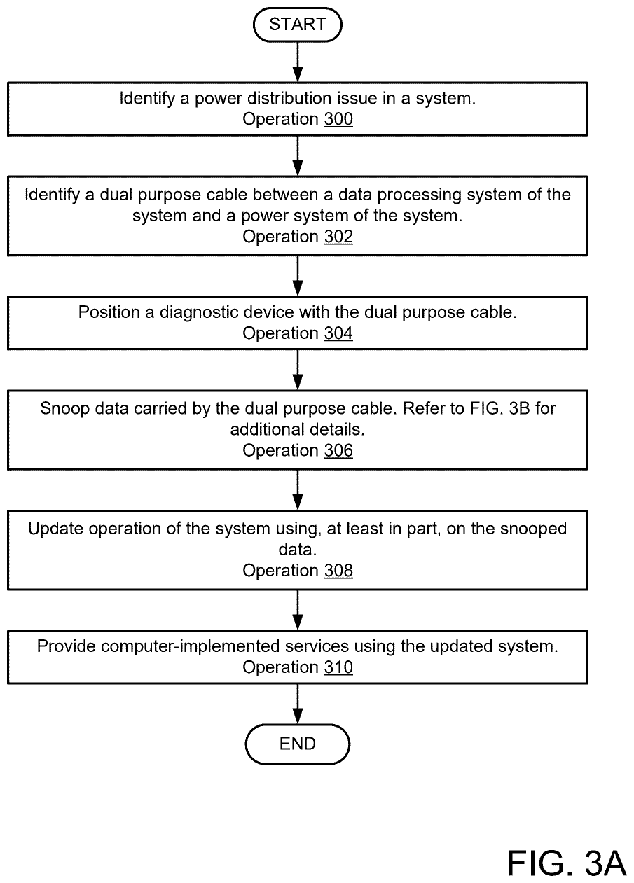

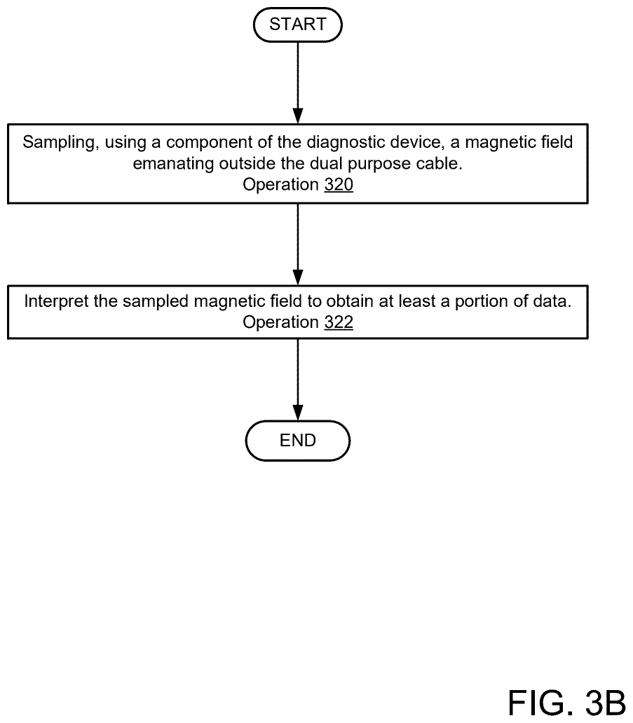

While providing their functionality, any of system 100, power system 102, diagnostic device 104, and dual purpose cable 110 may provide all or a portion of the methods shown in FIGS. 2-3B.

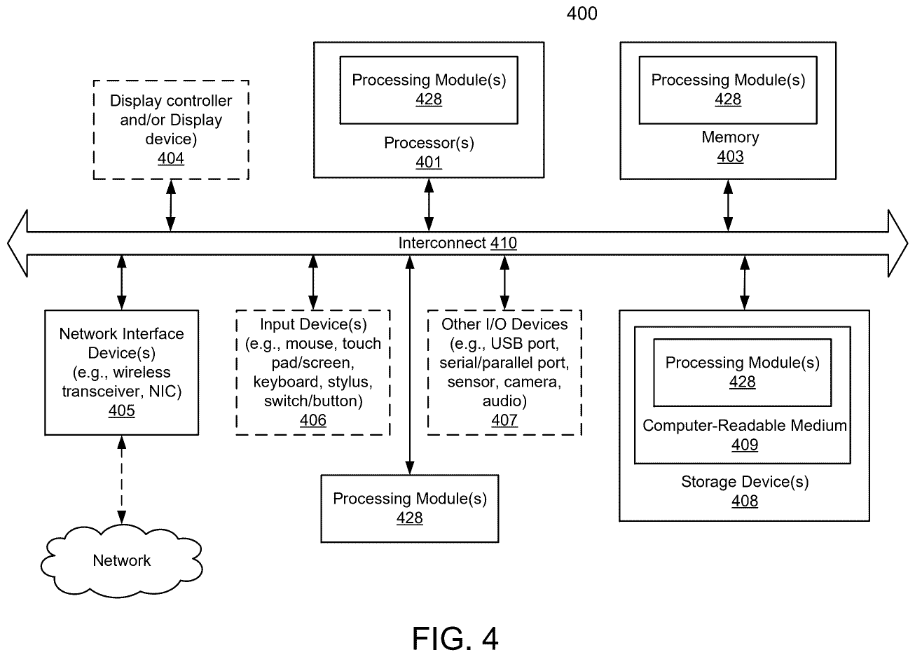

Any of (and/or components thereof) data processing systems 100, and diagnostic device 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of a system by using a diagnostic device to obtain data from a magnetic field emanating from a dual purpose cable connecting a power system of the system to a data processing system of the system. By doing so, operation of the system may be updated based at least on the data to provide computer-implemented services that may be less likely to be impacted by a power distribution issue.

While illustrated in FIG. 1 with a limited number of specific components, a system may include additional, fewer, and/or different components without departing from embodiments disclosed herein.

To further clarify embodiments disclosed herein, an interaction diagram in accordance with an embodiment is shown in FIG. 2. The interaction diagram may illustrate how data may be obtained and used within the system of FIG. 1.

In the interaction diagram, processes performed by and interactions between components of a system in accordance with an embodiment are shown. In the diagrams, components of the system are illustrated using a first set of shapes (e.g., 100, 102, etc.), located towards the top of each figure. Lines descend from these shapes. Processes performed by the components of the system are illustrated using a second set of shapes (e.g., 204, 206, etc.) superimposed over these lines. Interactions (e.g., communication, data transmissions, etc.) between the components of the system are illustrated using a third set of shapes (e.g., 202) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the process labeled as 202 may occur prior to the interaction labeled as 204. However, it will be appreciated that the processes and interactions may be performed in different orders, any may be omitted, and other processes or interactions may be performed without departing from embodiments disclosed herein.

Turning to FIG. 2, a first interaction diagram in accordance with an embodiment is shown. The first interaction diagram may illustrate processes and interactions that may occur during updating operation of a system based at least on data obtained regarding distribution of power between a power system of the system and a data processing system of the system.

Power/data signals 200 is shown in FIG. 2 to illustrate electromagnetic signals that may be propagated between data processing system 100 and power system 102, for example, by flowing across dual purpose cable 110 (not shown) while data processing system 100 and power system 102 are connected by dual purpose cable 110. Power/data signals 200 may include encoded data relevant to power distribution by power system 102, power consumption by data processing system 100, and/or any other information. For example, power/data signals 200 may include a waveform adapted to convey the encoded data by shaping the waveform based on a modulation schema.

While propagating along dual purpose cable 110, power/data signals 200 may generate a magnetic field (e.g., via induction) that emanates outside dual purpose cable 110 and may therefore be detectable by a device configured to detect electromagnetic fields (e.g., an inductive amplifier).

To obtain at least a portion of power/data signals 200, signal detecting process 204 may be performed. During signal detecting process 204, diagnostic device 104 may be positioned with dual purpose cable 110, and the magnetic field emanating from dual purpose cable 110 may be sampled. For example, to position diagnostic device 104, (i) a component of diagnostic device 104 may be positioned, by a user of diagnostic device 104, within a range (e.g., based on a flux of the magnetic field generated by power/data signals 200) of dual purpose cable 110 to detect the magnetic field without physical contact, (ii) be positioned in series with a power loop between data processing system 100 and power system 102 (e.g., as an intermediary connection with dual purpose cable 104), (iii) a circuit terminating device may be attached to the power loop, and/or any other processes.

To sample the magnetic field emanating from dual purpose cable 110, diagnostic device 104 may: (i) record readings of a snooped signal (e.g., at least a portion of power/data signals 200) for a period of time while positioned with dual purpose cable 110, (ii) convert an electromagnetic wave of the magnetic field to an electromagnetic signal, (iii) amplify the electromagnetic signal, and/or any other processes.

At interaction 202, a snooped signal may be obtained by diagnostic device 104 from power/data signals 200. For example, to obtain the snooped signal, diagnostic device 104 may (i) identify a portion of the sampled magnetic that may include data relevant to power distribution, (ii) store, at least temporarily, the snooped signal, and/or any other processes. By obtaining the snooped signal, diagnostic device 104 may interpret the snooped signal to identify data relevant to managing power distribution between power system 102 and data processing system 100.

To identify the data, signal interpreting process 206 may be performed. During signal interpreting process 206, the snooped signal may be decoded to obtain the data. For example, to decode the snooped signal, the snooped signal may be (i) processed (e.g., using a demodulation technique) by diagnostic device 104, (ii) filtered to remove noise and/or interference present in the snooped signal, (iii) extracting control information from the data, and/or any other processes.

To update operation of the system, updating process 208 may be performed. During updating process 208, a power distribution issue may be debugged based on the data, and operation of the system may be updated. For example, to debug the power distribution issue, (i) the data may be analyzed to identify undesired distribution and/or consumption of power, (ii) a communication issue may be identified between power system 102 and data processing system 100 (e.g., a rate of power distribution may be incompatible with a power supply level power desired by data processing system 100), (iii) power may be measured using a second component of diagnostic device 104 and compared to the data, and/or any other processes.

Operation of the system may be updated, for example, by (i) modifying connectivity of power system 102 and data processing system 100 (and/or any other data processing systems), (ii) limiting distribution of power to reduce a likelihood of undesired operation of power system 102, and/or any other processes.

Thus, using processes and interactions shown in FIG. 2, operation of a system may be updated based on data snooped by a diagnostic device from a dual purpose cable that may connect a data processing system of the system and a power system of the system for power distribution. By doing so, computer-implemented services may be provided using the updated system that may be less likely to be impacted by a power distribution issue.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage a system. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing operation of a system in accordance with an embodiment is shown. The method may be performed, for example, by any of the components of the system of FIG. 1, and/or other components not shown therein.

At operation 300, a power distribution issue in the system may be identified. The power distribution issue may be identified by: (i) monitoring a status of a power system in the system, (ii) obtaining an alert indicating the power distribution issue, (iii) observing, by an entity tasked with managing the system, undesired operation of the system with regard to power distribution and/or consumption, and/or any other processes.

At operation 302, a dual purpose cable between the data processing system and the power system may be identified. The dual purpose cable may be identified by: (i) tracing a cable connecting the data processing system and the power system, (ii) distinguishing the dual purpose cable from any number and/or types of other cables present in an environment of the system, (iii) using a component of a diagnostic device (e.g., an inductive amplifier) to identify connectivity of the dual purpose cable with respect to the data processing system and the power system, (iv) obtaining data from the dual purpose using the component of the diagnostic device, (v) attaching a second component of the diagnostic device (e.g., a circuit terminating device, a tone generator, etc.) to support operation of the first component of the diagnostic device, and/or any other processes.

At operation 304, a diagnostic device may be positioned with the dual purpose cable. The diagnostic device may be position with the dual purpose cable by: (i) placing a component of the diagnostic device within a range of the dual purpose cable (e.g., with or without physically contacting the dual purpose cable), (ii) positioning the diagnostic device in series with a power loop between the data processing system and the power system 102, and/or any other processes.

At operation 306, data carried by the dual purpose cable may be snooped. The data may be snooped by: (i) sampling, using a component of the diagnostic device (e.g., an inductive amplifier), a magnetic field emanating outside the dual purpose cable, (ii) interpreting the sampled magnetic field to obtain a portion of the data, and/or any other processes. Refer to FIG. 3B for additional details regarding snooping the data carried by the dual purpose cable.

At operation 308, operation of the system may be updated based, at least in part, on the snooped data. Operation of the system may be updated by: (i) modifying connectivity of the power system and data processing system (and/or any other data processing systems), (ii) limiting distribution of power to reduce a likelihood of undesired operation of the power system, and/or any other processes.

At operation 310, computer-implemented services may be provided using the updated system. The computer-implemented services may be provided by: (i) communicating, by the data processing system and via the dual purpose cable, desired power for operation of the data processing system, (ii) distributing, by the power system, the desired power to be consumed by the data processing system, (iii) coordinating, by the power system, power distribution to any number of other data processing systems, (iv) providing, by the data processing system, a portion of the computer-implemented services to a user of the data processing system, and/or any other processes.

The method may end following operation 310.

Using the method shown in FIG. 3A, operation of a system may be managed by updating operation of the system based at least in part on data relevant to power distribution obtained by a diagnostic device from a dual purpose cable connecting a data processing system of the system and a power system of the system.

Turning to FIG. 3B, a second flow diagram illustrating a method of snooping data carried by a dual purpose cable is shown. The method may be performed, for example, by any of the components of the system of FIG. 1, and/or other components not shown therein.

At operation 320, a magnetic field emanating out the dual purpose cable may be sampled using a component of the diagnostic device. The magnetic field may be sampled by: (i) detecting an electromagnetic signal propagating along the dual purpose cable using the component of the diagnostic device (e.g., an inductive amplifier, a probe, etc.), (ii) converting an electromagnetic wave of the magnetic field to the electromagnetic signal, (iii) amplifying the electromagnetic signal, (iv) recording readings of the electromagnetic signal for a period of time while positioned with the dual purpose cable, and/or any other processes.

At operation 322, the sampled magnetic field may be interpreted to obtain at least a portion of the data. The sampled magnetic field may be interpreted by: (i) filtering signals identified in the sampled magnetic field to remove noise and/or interference, (ii) demodulating the electromagnetic signal to extract the information encoded on the electromagnetic signal, (iii) decoding the electromagnetic signal (e.g., using digital signal processing algorithms) to convert data to control information usable to an entity tasked with managing the system, (iv) outputting the control information (e.g., using an interface of the diagnostic device), and/or any other processes.

The method may end following operation 322.

Using the method shown in FIG. 3B, data carried by a dual purpose cable connecting a data processing system and a power system may be snooped by a diagnostic device and interpreted to obtain information that may be usable to debug the system.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a system, the method comprising:
making an identification of a power distribution issue in the system;
based on the identification:
identifying a dual purpose cable between a data processing system of the system and a power system of the system, the dual purpose cable simultaneously carrying power and data between the data processing system and the power system;
positioning a diagnostic device with the dual purpose cable;
while the diagnostic device is positioned with the dual purpose cable:
snooping the data carried by the dual purpose cable;
updating operation of the system using, at least in part, the snooped data; and
providing computer implemented services using the updated system.

2. The method of claim 1, wherein snooping the data comprises:
sampling, using a component of the diagnostic device, a magnetic field emanating outside the dual purpose cable due to an electromagnetic signal propagating along the dual purpose cable on which the data carried by the dual purpose cable is encoded; and
interpreting the sampled magnetic field to obtain at least a portion of the data.

3. The method of claim 2, wherein the component is an inductive amplifier.

4. The method of claim 3, wherein the data comprises control information for managing distribution of power from the power system to the data processing system.

5. The method of claim 4, wherein the control information is further used for managing distribution of the power to other data processing systems of the system.

6. The method of claim 5, wherein the control information is used to limit the distribution of the power to reduce a likelihood of undesired operation of the power system.

7. The method of claim 1, wherein the power distribution issue is a communication issue between the power system and the data processing system.

8. The method of claim 1, wherein the dual purpose cable directly connects the power system to the data processing system.

9. The method of claim 8, wherein the power system comprises a power distribution unit to which the dual purpose cable is directly connected.

10. The method of claim 9, wherein the power distribution unit is adapted to receive power and provide power supply level power to the data processing system, the data processing system comprising a power supply to which the dual purpose cable is directly connected.

11. The method of claim 1, wherein the diagnostic device is in series with a power loop between the data processing system and the power system, the dual purpose cable being part of the power loop.

12. The method of claim 1, wherein the diagnostic device is outside of a power loop between the data processing system and the power system, the dual purpose cable being part of the power loop.

13. A diagnostic device for managing operation of a system, comprising:
a component for snooping data transmitted via dual purpose cable; and
a hardware processor adapted to:
while the diagnostic device is positioned with a dual purpose cable, snoop data carried by the dual purpose cable between a data processing system and a power system, the dual purpose cable simultaneously carrying power and data between the data processing system and the power system; and
facilitate use of the snooped data to facilitate updating of operation of a system comprising the data processing system and the power system so that the updated system provides computer implemented services.

14. The diagnostic device of claim 13, wherein snooping the data comprises:
sampling, using the component, a magnetic field emanating outside the dual purpose cable due to an electromagnetic signal propagating along the dual purpose cable on which the data carried by the dual purpose cable is encoded; and
interpreting the sampled magnetic field to obtain at least a portion of the data.

15. The diagnostic device of claim 14, wherein the component is an inductive amplifier.

16. The diagnostic device of claim 15, wherein the data comprises control information for managing distribution of power from the power system to the data processing system.

17. A non-transitory machine-readable medium having instructions stored therein, which when executed by a processor, cause the processor to perform operations for managing operation of a system using a diagnostic device, the operations comprising:
while the diagnostic device is positioned with a dual purpose cable, snooping data carried by the dual purpose cable between a data processing system and a power system, the dual purpose cable simultaneously carrying power and data between the data processing system and the power system; and
facilitating use of the snooped data to facilitate updating of operation of a system comprising the data processing system and the power system so that the updated system provides computer implemented services.

18. The non-transitory machine-readable medium of claim 17, wherein the snooping the data comprises:
sampling, using the component of the diagnostic device, a magnetic field emanating outside the dual purpose cable due to an electromagnetic signal propagating along the dual purpose cable on which the data carried by the dual purpose cable is encoded; and
interpreting the sampled magnetic field to obtain at least a portion of the data.

19. The non-transitory machine-readable medium of claim 18, the component is an inductive amplifier.

20. The non-transitory machine-readable medium of claim 19, wherein the data comprises control information for managing distribution of power from the power system to the data processing system.
